(19) United States
(12) Patent Application Publication
(10) Pub. No.: US 2025/0346513 A1
(43) Pub. Date: Nov. 13, 2025

(54) WASTEWATER TREATMENT METHOD AND WASTEWATER TREATMENT APPARATUS

(71) Applicant: ORGANO CORPORATION, Tokyo (JP)

(72) Inventors: Taichi YAMAMOTO, Tokyo (JP); Hironori YUI, Tokyo (JP); Yoshiaki HASEBE, Tokyo (JP)

(73) Assignee: ORGANO CORPORATION, Tokyo (JP)

(21) Appl. No.: 18/874,268

(22) PCT Filed: Apr. 27, 2023
(86) PCT No.: PCT/JP2023/016627

§ 371 Date: Dec. 12, 2024

(30) Foreign Application Priority Data
Jun. 14, 2022 (JP) 2022-095951

(51) Int. Cl. C02F 3/00; C02F 3/08; C02F 101/16

(52) U.S. Cl. CPC C02F 3/006; C02F 3/085; C02F 2101/16; C02F 2209/245; C02F 2301/08; C02F 2305/06

(57) ABSTRACT

A wastewater treatment apparatus is equipped with: a reaction tank that performs aerobic biological treatment on organic wastewater containing at least one of a sulfur compound and a nitrogen compound; a filter for removing the corrosive gas from the gas discharged from water in the reaction tank; a sensor for measuring carbon dioxide concentration contained in the gas after the corrosive gas has been removed; and a control device for controlling the aerobic biological treatment based on the carbon dioxide concentration measured by the measurement means.

### TECHNICAL FIELD

The present invention relates to a wastewater treatment method and a wastewater treatment apparatus for treating organic wastewater by aerobic biological treatment.

### BACKGROUND ART

Biological treatment using microorganisms is generally used as wastewater treatment performed before discharging wastewater containing organic matters, i.e., organic wastewater, into the environment. In the biological treatment, environmental conditions such as water temperature and pH must be optimized and nutritive substances such as nitrogen, phosphorus, and trace metals need to be added in order to maintain high decomposition activity of organic substances by microorganisms. The control of the biological treatment includes determining the additive amount of the nutritive substances. As compared with the wastewater in public sewerage systems into which domestic wastewater flows, the nutritive substances are likely to be insufficient in the wastewater from factories. In particular, in the wastewater from a chemical factory or a semiconductor manufacturing plant, shortage of the nutritive substances required for biological treatment is remarkable.

It is recommended that the amount of nutritive substances added to raw water that is organic wastewater is proportional to the concentration of organic matter in the raw water. Assuming that the organic matter concentration in the raw water is represented by biochemical oxygen demand (BOD), the preferable additive amount of nitrogen (N) and phosphorus (P) as nutritive substances in wastewater treatment by aerobic microorganisms, i.e., aerobic biological treatment, is, for example, BOD:N:P=100:5:1 in terms of mass. It is difficult to perform BOD measurement of the raw water online or in a short time. However, since the measurement of total organic carbon (TOC) concentration in water can be performed online, it is performed that a correlation between TOC concentration and BOD in the raw water is acquired in advance, and the TOC concentration of the raw water is monitored by an online TOC concentration meter and converted into a BOD value, and then the additive amount of nitrogen and phosphorus is controlled based on the obtained BOD value. Such a control of the additive amount of nitrogen and phosphorus is disclosed in, for example, Patent Literature 1.

In the case of performing wastewater treatment by aerobic microorganisms, in general, when the concentration of dissolved oxygen (DO) in water in a reaction tank is 3 mg/L or more, the fully aerobic condition is considered to be satisfied. In the biological treatment under the fully aerobic condition, sulfur components in the organic wastewater are oxidized to sulfate ions (SO₄²⁻). In contrast to the aerobic biological treatment, biological treatment using anaerobic microorganisms is referred to as anaerobic biological treatment. In an anaerobic biological treatment such as methane fermentation, it is known that a corrosive gas such as hydrogen sulfide is generated, as described in Patent Literature 2.

### CITATION LIST

### Patent Literature

Patent Literature 1: JP 2001-334285 A

Patent Literature 2: JP 2005-81264 A

### SUMMARY OF INVENTION

### Technical Problem

In the method for controlling the additive amount of the nutritive substance on the basis of the TOC concentration measured online, clogging occurs inside piping of the online TOC concentration meter due to accumulation of suspended solids (SS) and oil contents, formation of a biofilm, etc., and the measured value becomes unstable. As a result, problem arises that the biological treatment itself cannot be stably performed. In addition, even when aerobic biological treatment is performed under a high BOD volumetric loading condition, the treatment may also be unstable.

The object of the present invention is to provide a wastewater treatment method and a wastewater treatment apparatus capable of stably carrying out aerobic biological treatment when performing aerobic biological treatment of organic wastewater.

### Solution to Problem

The present inventors have found that, when performing aerobic biological treatment of organic wastewater, the concentration of carbon dioxide generated from the water in the reaction tank can be measured, and the amount of the nutritive substance to be added can be determined from the measured carbon dioxide concentration. Since the measurement of the carbon dioxide concentration is performed in a gas phase, it is possible to avoid the occurrence of problems such as accumulation of suspended solids and oil contents, formation of a biofilm, etc. in the measurement of TOC concentration. With regard to a case that the biological treatment of organic wastewater containing a sulfur compound is performed under the fully aerobic condition in which the concentration of dissolved oxygen (DO) in water in a reaction tank is 3 mg/L or more, the present inventors have further found that, if the volume loading of the organic substances in the biological treatment is large, for example, the loading exceeds 1.5 kg/m³/day expressed as BOD volume loading, hydrogen sulfide that is a product in anaerobic treatment may be generated. Hydrogen sulfide gives damage to the sensors used to measure the carbon dioxide concentration. Similarly, when the organic wastewater contains a nitrogen compound, if the BOD volume loading is large, ammonia or the like may be generated even in the biological treatment under the fully aerobic condition. Since ammonia may adversely affect wiring or the like in the sensor, ammonia is also considered to be a corrosive gas.

Therefore, the wastewater treatment method according to one aspect of the present invention is a wastewater treatment method for performing aerobic biological treatment on organic wastewater containing at least one of a sulfur compound and a nitrogen compound in a reaction tank, the water treatment method being characterized by removing corrosive gas from gas discharged from water in the reaction tank, measuring carbon dioxide concentration in the gas after removing the corrosive gas, and controlling the aerobic biological treatment based on the measured carbon dioxide concentration.

The wastewater treatment apparatus according to one aspect of the present invention includes: a reaction tank that performs aerobic biological treatment on organic wastewater containing at least one of a sulfur compound and a nitrogen compound; a removal means for removing the corrosive gas from gas discharged from the water in the reaction tank; a measurement means for measuring carbon dioxide concentration contained in the gas after the corrosive gas has been removed; and a control means for controlling the aerobic biological treatment based on the carbon dioxide concentration measured by the measurement means.

As described above, even when the organic wastewater is biologically treated under the fully aerobic conditions, a corrosive gas such as hydrogen sulfide or ammonia is generated if the volume loading of the organic matters in the biological treatment in the reaction tank is large. In the wastewater treatment method and the wastewater treatment apparatus described above, before the concentration of carbon dioxide contained in the gas generated from the reaction tank is measured, the corrosive gas contained in the gas is removed. As a result, it is possible to prevent adverse effects on the sensors for measuring the carbon dioxide concentration, and stably control the aerobic biological treatment based on the carbon dioxide concentration when performing the aerobic biological treatment.

### Advantageous Effect of Invention

In the wastewater treatment method and the wastewater treatment apparatus, the aerobic biological treatment can be stably performed even when the volume loading of the organic matter in the organic wastewater is large.

### BRIEF DESCRIPTION OF DRAWINGS

FIG. 1 is a diagram illustrating a wastewater treatment apparatus according to an embodiment of the present invention;

FIG. 2 is a diagram illustrating a wastewater treatment apparatus according to another embodiment; and

FIG. 3 is a diagram illustrating a wastewater treatment apparatus according to yet another embodiment.

### DESCRIPTION OF EMBODIMENTS

Next, embodiments of the present invention will be described with reference to the drawings.

Embodiments described below relate to a technique for performing biological treatment using aerobic microorganisms, i.e., aerobic biological treatment, for raw water that is organic wastewater to decompose and remove organic substances in the raw water. In the wastewater treatment method based on the present invention, organic wastewater to be subjected to decomposition and removal of organic substances is not particularly limited as long as aerobic biological treatment can be applied. For example, the organic wastewater includes: wastewater from public sewage systems; and wastewater discharged from each factory such as a food factory, chemical factory, semiconductor manufacturing factory, liquid crystal manufacturing factory, paper pulp factory, and further includes wastewater discharged from business places in the fields other than those. As compared with the wastewater in public sewerage systems, the nutritive substance necessary for maintaining high decomposition activity of microorganisms used for biological treatment is likely to be insufficient in the wastewater in private-sector factories. In particular, shortage of nutritive substances is remarkable in the wastewater from a chemical factory, a semiconductor manufacturing factory, and a liquid crystal manufacturing factory. In the wastewater treatment method according to the present invention, an activated sludge method, a membrane bioreactor (MBR) method, a biological membrane method by a fluidized bed or a fixed bed, a granule method, or the like can be preferably used as the aerobic biological treatment.

In the wastewater treatment method based on the present invention, aerobic biological treatment is controlled so as to be performed under optimum conditions as much as possible for the aerobic biological treatment. In the control of the aerobic biological treatment, for example, the water temperature, pH, and the amount of air blown into the reaction tank can be controlled. In particular, it is preferable to control the additive amount of the nutritive substance to the raw water. In the embodiments described below, the additive amount of the nutritive substance to raw water that is the organic wastewater may be controlled as the control of the aerobic biological treatment. However, in the wastewater treatment method based on the present invention, the parameters other than the additive amount of the nutritional substance may be controlled.

In each embodiment, to optimize the amount of the nutritive substance added to the raw water, the concentration of carbon dioxide in gas discharged from water in the reaction tank is measured rather than directly measuring the BOD or TOC concentration of the raw water. Each embodiment assumes aerobic biological treatment, and in the aerobic biological treatment, an air diffusion or aeration treatment is usually performed on the water in the reaction tank by supplying a gas containing oxygen, such as air, to the reaction tank using a blower for air blowing. Therefore, it is preferable to measure the flow rate of the gas supplied to the reaction tank or the gas discharged from the reaction tank, together with the carbon dioxide concentration. The additive amount of the nutritive substance to the raw water is controlled based on the measured value of the carbon dioxide concentration, or based on the measured values of the carbon dioxide concentration and the flow rate of the gas.

In the case of performing the control based on the measured value of the carbon dioxide concentration and the measured value of the flow rate of the gas, the organic matter concentration of the raw water may be calculated from the measured value of the carbon dioxide concentration and the measured value of the flow rate, and then the additive amount of the nutritive substance to the raw water may be controlled based on the calculated organic matter concentration,. The additive amount of the nutritive substance to the raw water may be controlled based on the value obtained by multiplying the measured value of the concentration and the measured value of the flow rate. Further, the water quality (for example, pH) of the water in the reaction tank may be measured, and then the additive amount of the nutritive substance to the raw water may be controlled based on the measured value of the carbon dioxide concentration, the measured value of the flow rate, and the measured value of the water quality. As the flow rate of the gas, the flow rate of air supplied from the blower for air blowing to the reaction tank may be measured, or the flow rate of the entire gas discharged from the reaction tank may be measured. When the aerobic treatment is performed using a fluidized bed, a screen is disposed in the reaction tank in order to separate the carrier, and air is blown into to clean the screen. At this time, the flow rate of the gas may be obtained by adding the air flow rate of the blower for the air diffusion and the air flow rate of the air for cleaning the screen.

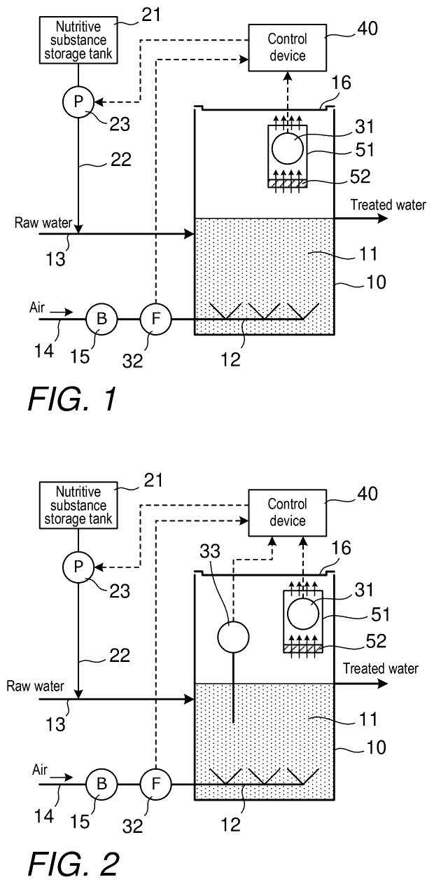

FIG. 1 illustrates a wastewater treatment apparatus according to an embodiment of the present invention. The wastewater treatment apparatus shown in FIG. 1 includes: reaction tank 10 of a fluidized bed type for storing raw water that is organic wastewater and performing biological treatment of the raw water under aerobic conditions. From reaction tank 10, treated water in which organic matter is decomposed and removed by the biological treatment is discharged. Reaction tank 10 is filled with carrier 11, and air diffusion device 12 for blowing air into reaction tank 10 for supplying oxygen, that is, for aeration, is provided at the bottom of reaction tank 10. Inlet pipe 13 for supplying the raw water to reaction tank 10 is connected to reaction tank 10. Gas pipe 14 for supplying air to air diffusion device 12 is connected to air diffusion device 12, and blower 15 for air supply is provided in gas pipe 14. Examples of carrier 11 that can be used here include, for example, a plastic carrier, a sponge-like carrier, a gel-like carrier, and the like, it is preferable to use a sponge-like carrier from the viewpoint of cost and durability. Reaction tank 10 may be provided with a stirring device for stirring carrier 11.

In the biological treatment, the microorganism needs a nutritive substance to maintain its decomposition activity and proliferate, and when the nutritive substance is insufficient in the raw water, it is necessary to add the nutritive substance to the raw water in the interior of reaction tank 10 or in the preceding stage of reaction tank 10. The nutritive substance is added to the raw water in the form of a solution, for example. The solution of the nutritive substance is also referred to as nutritious liquid. In the wastewater treatment apparatus shown in FIG. 1, a nutritive substance storage tank 21 for storing the nutritious liquid is provided, and nutritive substance storage tank 21 and inlet pipe 13 are connected via nutritious liquid pipe 22. Nutritious liquid pipe 22 is provided with pump 23 for feeding the nutritious liquid. Therefore, in this wastewater treatment apparatus, the nutritive substance can be added to the raw water flowing through inlet pipe 13 and supplied to reaction tank 10, and the amount of the nutritive substance added to the raw water can be controlled by controlling pump 23. The nutritive substance is classified into a nutrient salt containing nitrogen and phosphorus, and a trace element having a smaller necessary amount than nitrogen and phosphorus. The trace elements include: alkali metals such as sodium, potassium, calcium and magnesium; metals such as iron, manganese and zinc. Urea or ammonium salt can be used as a nitrogen source. Phosphoric acid or phosphate can be used as a phosphorus source.

In the wastewater treatment apparatus shown in FIG. 1, the additive amount of the nutritive substance is controlled based on the carbon dioxide concentration in the gas released from the water in reaction tank 10 by the aerobic biological treatment and the flow rate of the air supplied to reaction tank 10 for air diffusion. Therefore, reaction tank 10 is provided with carbon dioxide concentration sensor 31 for measuring the carbon dioxide concentration in the gas discharged from the water in reaction tank 10, and gas pipe 14 is provided with air flow meter 32 for measuring the flow rate of the air flowing therein at a position between blower 15 and air diffusion device 12. As reaction tank 10 is covered with lid 16, carbon dioxide concentration sensor 31 is installed in a gas phase portion in reaction tank 10 or a pipe connected to the gas phase portion. Since the dew condensation of carbon dioxide concentration sensor 31 needs to be avoided, a mist separator or air dryer may be installed at the position immediately in front of carbon dioxide concentration sensor 31, as well as to keep the piping warm when the carbon dioxide concentration sensor 31 is installed in the piping.

When reaction tank 10 is an open system, the open portion at the top portion of reaction tank 10 is reduced as much as possible in order to reduce the influence of the outside air in the measurement result, and a cylindrical pipe or the like can be inserted below the water surface, and carbon dioxide concentration sensor 31 can be disposed at a position above the water surface in that pipe. As carbon dioxide concentration sensor 31, for example, an optical type, an electrochemical type or a semiconductor type can be used, but it is preferable to use a sensor by a non-dispersive infrared absorption (NDIR) method. The measurement of the carbon dioxide concentration may be performed manually or online.

As will be apparent from Examples and Comparative Examples described below, even if the concentration of dissolved oxygen (DO) in the water in reaction tank 10 is 3 mg/L or more and the fully aerobic condition is satisfied, hydrogen sulfide derived from a sulfur compound contained in the raw water may be generated when the BOD volume loading of the aerobic biological treatment in reaction tank 10 is large, for example, when the loading exceeds 1.5 kg/m³/day. In addition, ammonia derived from a nitrogen compound may occur. Hydrogen sulfide and ammonia are corrosive gases and may corrode the interior of carbon dioxide concentration sensor 31. When carbon dioxide concentration sensor 31 is damaged by the corrosive gas, it becomes difficult to obtain a stable measurement value, and it is difficult to appropriately control the additive amount of the nutritive substance. Therefore, in the wastewater treatment apparatus shown in FIG. 1, before the carbon dioxide concentration of the gas discharged from the water in reaction tank 10 is measured by carbon dioxide concentration sensor 31, pretreatment for removing the corrosive gas from the gas is executed. General methods for removing hydrogen sulfide includes: a method for removing hydrogen sulfide as iron sulfide by contacting with iron oxide; a method for removing hydrogen sulfide by absorption in an alkali agent such as sodium hydroxide. However, since carbon dioxide is also absorbed and removed by the alkali agent method, the method using iron oxide is preferable in the present embodiment.

In the example shown in FIG. 1, it is assumed that a sulfur compound is contained in raw water that is organic wastewater, and hydrogen sulfide may be generated. Carbon dioxide concentration sensor 31 is disposed inside tubular member 51, and desulfurization filter 52 is provided at one end of tubular member 51. In tubular member 51, by a fan or an air pump (not shown), gas flows in one direction as shown by the illustrated arrow, and the gas from which hydrogen sulfide has been removed through desulfurization filter 52 is supplied to carbon dioxide concentration sensor 31. In the figure, the other end of tubular member 51 is also inside reaction tank 10, but tubular member 51 may be provided so as to penetrate lid 16, and the gas measured by carbon dioxide concentration sensor 31 may be discharged to outside of reaction tank 10. Desulfurization filter 52 is a filter for removing hydrogen sulfide using iron oxide, and is filled with a filler material containing iron oxide, for example. The filler material may be, for example, a granular or columnar shape with a diameter of 4 to 12 mm, or may be processed into a porous honeycomb shape. From the height of the processing performance, a honeycomb-shaped filler material is preferably used. The spatial velocity (SV) of the gas in desulfurization filter 52 is, for example, about 10 to 180 h⁻¹.

Next, the control of the additive amount of the nutritive substance in the wastewater treatment apparatus illustrated in FIG. 1 will be described. It is recommended that the amount of addition when adding a nutritive substance (nutrient salt and trace metal) to the raw water is proportional to the concentration of organic matters, preferably BOD, in the raw water. For example, it is recommended that the additive amount of nitrogen (N) and phosphorus (P) in the aerobic treatment is to be BOD:N:P=100:5:1 on a mass basis. In the wastewater treatment apparatus shown in FIG. 1, the BOD of the raw water is not measured by an online TOC concentration meter or the like, and instead, the carbon dioxide concentration in the gas released from the water in reaction tank 10 by the aerobic biological treatment and the flow rate of the air supplied to reaction tank 10 for air diffusion, that is, the air flow rate, are measured. Then, the BOD value of the raw water is calculated from the measured value of the carbon dioxide concentration and the measured value of the flow rate of the air, and the additive amount of the nutritive substance is determined based on the calculated BOD value. For that purpose, the combination of the carbon dioxide concentration measured by carbon dioxide concentration sensor 31 and the measured value of the air flow rate obtained by air flow meter 32 is taken as an input value (Xn), the BOD concentration of the raw water corresponding to the input value (Xn) is taken as an output value (Yn). After obtaining a certain number of combinations of the input value and the output value in advance, a model or a relational expression is created. The number of combinations to be acquired is, for example, several tens to hundred sets. At this time, instead of using the combination of the carbon dioxide concentration and the measured value of the air floe rate as the input value (Xn), the value obtained by multiplying the measured value of the carbon dioxide concentration and the measured value of the air flow rate, that is, the multiplication value, may be taken as the input value (Xn). In the case of a method by the multiplication value, if the air flow rate is constant, only the measured value of the carbon dioxide concentration can be used instead of the multiplication value.

Once the model is created, the combination of the measured value of the carbon dioxide concentration measured by carbon dioxide concentration sensor 31 and the measured value of the air flow rate obtained by air flow meter 32 is entered to the model, and based on the resulting BOD concentration output from the model, pump 23 is driven to control whether or not the nutrient substance is added to the raw water and the additive amount of the nutritive substance. In order to perform such control, the wastewater treatment apparatus includes control device 40 that holds the created model, calculates the BOD concentration value of the raw water by applying the carbon dioxide concentration value obtained by carbon dioxide concentration sensor 31 and the measured value obtained by air flow meter 32 to the model, and controls start-and-stop and the floe rate of pump 23 on the basis of the BOD concentration value. Although the BOD concentration is used for the creation of the model, the created model itself can be considered to directly output the additive amount of the nutritive substance by inputting the measured value of the carbon dioxide concentration and the measured value of the air flow rate, and therefore, the optimum additive amount of the nutritive substance can be determined without explicitly calculating the BOD concentration value from the measured value of the carbon dioxide concentration and the measured value of the air flow rate.

Next, the creation of the model will be described. The model that outputs, as an output value, the BOD concentration of the raw water corresponding to an input value when the input value is entered can be created using, for example, various types of regression analysis. In particular, when the model is created by supervised learning using a neural network technology, the accuracy of the control of the additive amount of the nutritive substance is improved. The carbon dioxide concentration obtained by carbon dioxide concentration sensor 31 may vary depending on the configuration and size of reaction tank 10, the size of the gas phase portion in reaction tank 10, the type of biological treatment, and the like, and the air flow rate of the air supplied to reaction tank 10 for air diffusion changes depending on the configuration and size of reaction tank 10, and the like. Thus, the model may be set for each reaction tank 10. Further, since there is a possibility that the relationship of the BOD of the raw water to the measured carbon dioxide concentration and the measured air flow rate varies depending on the type or source of the raw water, a model is prepared for each type of the raw water and each source, and a model to be used for controlling the additive amount of the nutritive substance can be selected from the models prepared in such a manner in accordance with the type and source of the raw water.

In the wastewater treatment apparatus shown in FIG. 1, air flow meter 28 is provided in gas pipe 14 to measure the flow rate of air, i.e., air flow rate, of the air supplied to reaction tank 10 via gas pipe 14. However, the flow rate of gas discharged from reaction tank 10 may be measured instead of measuring the flow rate of the air supplied to reaction tank 10. In case of measuring the flow rate of the gas discharged from reaction tank 10, air flow meter 32 may be installed in a pipe communicating with the inside of reaction tank 10 for discharging the gas to the outside when reaction tank 10 is completely covered by lid 16. When reaction tank 10 is an open system, the open portion at the top portion of reaction tank 10 is reduced as much as possible in order to reduce the influence of the outside air in the measurement result, and a cylindrical pipe or the like can be inserted below the water surface, and air flow meter 32 can be installed in the pipe.

In order to control the amount of the nutritive substance added to the raw water, it is also conceivable to measure the concentration of organic matters in the raw water online using an online TOC concentration meter. However, the online TOC concentration meter is provided with a thin pipe for drawing a small amount of sample water into the measuring device, and clogging easily occurs and the measured value is not stabilized. In contrast, since carbon dioxide concentration sensor 31 performs measurement without coming into contact with water, the stability of the measured value is very high. Further, the gas flow rate can be also measured stably. Therefore, in the wastewater treatment apparatus shown in FIG. 1, the optimum value of the additive amount of the nutritive substance to the raw water can be stably determined without directly measuring the concentration of organic matters in the raw water.

FIG. 2 illustrates a wastewater treatment apparatus according to another embodiment of the present invention. The wastewater treatment apparatus shown in FIG. 2 is a modification of the wastewater treatment apparatus shown in FIG. 1 so that water quality measurement unit 33 for measuring the water quality of water in reaction tank 10 is provided, and the measurement result in water quality measurement unit 33 is also sent to control device 40. The water quality item measured by water quality measurement unit 33 includes at least pH, and water temperature or the like may be measured other than pH. The model used in the wastewater treatment apparatus shown in FIG. 2 takes, as an input (Xn), a combination of the carbon dioxide concentration measured by carbon dioxide concentration sensor 31, the measured value of the air flow rate obtained by air flow meter 32 and the measured value of the water quality (particularly pH) measured by water quality measurement unit 33, and uses the BOD concentration of the raw water corresponding to the input value (Xn) as an output value (Yn). The model is created in the same manner as described above. Control device 40 calculates the BOD concentration value of the raw water by applying the measured value of the carbon dioxide concentration measured by carbon dioxide concentration sensor 31 and the measured value of the air flow rate obtained by air flow meter 32 and the measured value of the water quality (particularly pH) measured by water quality measurement unit 33 to the model, and controls pump 23 on the basis of the BOD concentration value.

As well known, inorganic carbonic acid changes its form in water to CO₂, HCO₃⁻, and CO₃²⁻ in accordance with pH. Therefore, even if the organic matter concentration in the raw water is the same, the carbon dioxide concentration in the gas released from the water in reaction tank 10 may change according to the pH. In the wastewater treatment apparatus shown in FIG. 2, since the additive amount of the nutritive substance is controlled in consideration of the pH of water in reaction tank 10, the additive amount of the nutritive substance can be optimized regardless of the pH of the raw water. The solubility of carbon dioxide in water depends on the water temperature, and the carbon dioxide concentration in the gas discharged from the water in reaction tank 10 changes when the solubility of carbon dioxide changes. Therefore, when there is a water temperature variation in reaction tank 10, the water temperature is also measured in addition to pH in water quality measurement unit 33, and the additive amount of the nutritive substance can also be controlled on the basis of the water temperature in addition to the carbon dioxide concentration, the air flow rate, and the pH.

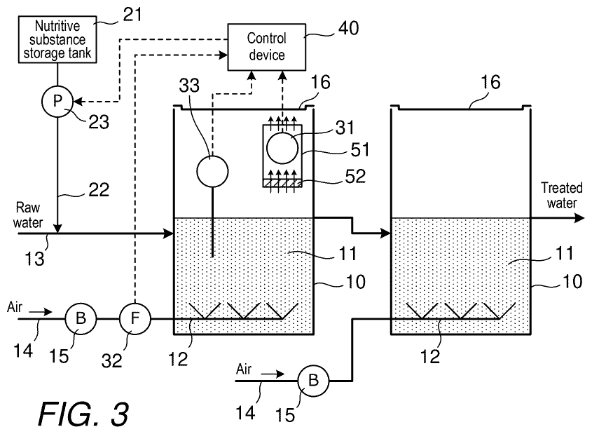

In wastewater treatment, a plurality of reaction tanks that perform biological treatment are sometimes connected in series, and the treated water discharged from the reaction tank of the preceding stage is led to the reaction tank of the next stage to perform the biological treatment in each reaction tank, thereby obtaining the treated water in which organic matters are highly removed. FIG. 3 illustrates a wastewater treatment apparatus which performs wastewater treatment by aerobic biological treatment in the same manner as those shown in FIGS. 1 and 2, and in which a plurality of reaction tanks 10 are provided in series, i.e., in multiple stages. When reaction tanks 10 are provided in multiple stages of two or more stages, it is possible to measure, at reaction tank 10 in the frontmost stage, the concentration of carbon dioxide in the gas discharged from that reaction tank and the air flow rate of the air supplied to that reaction tank, and then the BOD concentration value of the raw water can be calculated from the carbon dioxide concentration and the air flow rate of the air. The amount of the nutritive substance added to the raw water supplied to that reaction tank can be controlled based on the BOD concentration value. In this case, the pH of the water in reaction tank 10 in the frontmost stage may be also measured, and the additive amount of the nutritive substance to the raw water can be controlled based on the carbon dioxide concentration, the air flow rate and the pH. Accordingly, in the wastewater treatment apparatus shown in FIG. 3, carbon dioxide concentration sensor 31, air flow rate meter 32 and water quality measurement unit 33 are provided only in reaction tank 10 of the frontmost stage, and the nutritious liquid from nutritive substance storage tank 21 is added to the raw water in inlet pipe 13 connected to reaction tank 10 in the frontmost stage. Similar to the apparatus shown in FIG. 1, carbon dioxide concentration sensor 31 is provided inside tubular member 51 provided with desulfurization filter 52 at one end. Control device 40 calculates the BOD concentration value of the raw water from the measured values of carbon dioxide concentration sensor 31, air flow meter 32, and water quality measurement unit 33, and controls pump 23 for feeding the nutritious liquid on the basis of the BOD concentration value.

When two or more stages of reaction tanks 10 are provided in series, most of the organic matter is decomposed and removed in reaction tank 10 of the frontmost stage, so that the organic matter that must be removed in reaction tank 10 in the second and subsequent stages is reduced. In addition, the nutritive substances is re-eluted by killing and dismantling of the microorganisms proliferated in reaction tank 10 in the frontmost stage. For these reasons, the biological treatment can proceed in reaction tanks 10 in the second and subsequent stages without adding the nutritive substance to the water supplied to reaction tanks 10 in the second and subsequent stages, or without any special control of the biological treatment in reaction tanks 10 in the second and subsequent stage. The overall treatment performance of the wastewater treatment system can be maintained. Therefore, it is not necessary to measure the carbon dioxide concentration, the air flow rate, and the pH for the reaction tanks in the second and subsequent stages.

### EXAMPLES

Next, the present invention will be further described in detail by Examples, Comparative Examples, and Reference Examples.

### Example 1, Reference Example 1, and Comparative Examples 1 and 2

First, a test condition common to Example 1, Reference Example 1, and Comparative Examples 1 and 2 will be described. The wastewater treatment apparatus was configured by preparing a reaction tank for performing aerobic biological treatment similar to that shown in FIG. 1. The top portion of the reaction tank was covered with a lid. The reaction tank was filled with a sponge carrier made of a hydrophobic polyurethane so as to have a filling rate of 20% as a bulk volume. Wastewater containing isopropyl alcohol was prepared as the organic wastewater. The BOD concentration of the wastewater was 180 to 330 mg/L, the nitrogen (N) concentration was 10 to 26 mg/L, the phosphorus (P) concentration was 0.5 mg/L or less, and the sulfate ion (SO₄²⁻) concentration was 60 to 360 mg/L. Such wastewater was supplied to the reaction tank, the aeration was performed in the reaction tank, the nutritive substance was added, and the aerobic biological treatment of the wastewater was performed. Phosphoric acid and a trace amount of metal were used as the nutritive substances. The water temperature at this time was about 30° C., the pH of the water in the reaction tank was 6.5 to 7.0, the dissolved oxygen concentration was 3 mg/L or more, and the fully aerobic condition was satisfied.

In order to measure the carbon dioxide concentration of the gas discharged from the water in the reaction tank, a pipe communicating with the gas phase portion of the reaction tank was provided, the gas was extracted from the pipe by an air pump, and the carbon dioxide concentration of the extracted gas was continuously measured by the carbon dioxide concentration sensor. The carbon dioxide concentration sensor was a sensor based on the non-dispersive infrared absorption (NDIR) method. This carbon dioxide concentration sensor attached to the reaction tank is referred to as a sensor for control. In Example 1, the gas drawn out from the pipe was passed through a column filled with a honeycomb-shaped filler with a surface coated with iron oxide in an upward flow, and then the carbon dioxide concentration of the gas was measured by the sensor for control. This column corresponds to a desulfurization filter. On the other hand, in Comparative Examples 1 and 2 and Reference Example 1, the carbon dioxide concentration of the gas extracted from the pipe was measured as it is by the sensor for control without providing the desulfurization filter.

### Example 1

The BOD volume loading of the aerobic biological treatment in the reaction tank was set to 4 kg/m³/day to perform the continuous operation of the wastewater treatment apparatus, and the continuous measurement of the carbon dioxide concentration by the sensor for control was performed after performing the pretreatment by the desulfurization filter. At a time where about three months elapsed from the start of the operation, the carbon dioxide concentration in the gas was measured, using a measurement device different from the sensor for control, by sampling the gas generated from the water in the reaction tank, and this carbon dioxide concentration in the gas was compared with the measured value by the sensor for control at that time. The measured carbon dioxide concentration is referred to as a standard gas concentration. As a result, the measured value by the sensor for control has a value of 107% of the standard gas concentration. The standard gas concentration is considered to correspond to the actual value of the carbon dioxide concentration at that time, and in Example 1, the measurement error in the sensor for control was within the allowable range.

### Comparative Example 1

Similar to Example 1 except that the carbon dioxide concentration was measured by the sensor for control without providing the desulfurization filter, the continuous operation of the wastewater treatment apparatus was performed under the condition that the BOD volume loading was 4 kg/m³/day, and the continuous measurement of the carbon dioxide concentration was performed. As a result, at a time where about three months elapsed from the start of the operation, the sensor for control experienced a sensor error and was unable to measure the carbon dioxide concentration. At this time, the hydrogen sulfide concentration of the gas generated from the reaction tank was measured to 0.7 ppm or more.

### Comparative Example 2

Similar to Comparative Example 1 except that the BOD volume loading was set to 3 kg/m³/day, the continuous operation of the wastewater treatment apparatus was performed, and the continuous measurement of carbon dioxide concentration was also performed. As a result, at a time where about three months elapsed from the start of the operation, the measured value of the carbon dioxide concentration by the sensor for control was about 140% of the standard gas concentration, and the sensor for control was in a state with a large measurement error. At this time, hydrogen sulfide was detected from the gas generated from the reaction tank.

### Reference Example 1

Similar to Comparative Example 1 except that the BOD volume loading was set to 1.5 kg/m³/day, the continuous operation of the wastewater treatment apparatus was performed, and the continuous measurement of carbon dioxide concentration was also performed. As a result, at a time where about three months elapsed from the start of the operation, the measured value of the carbon dioxide concentration by the sensor for control was about 105% of the standard gas concentration, and the measurement error in the sensor for control was within the allowable range.

From Reference Example 1 and Comparative Examples 1 and 2, it was found that hydrogen sulfide, which should normally be generated only under anaerobic conditions, is generated from the reaction tank when the BOD loading volume exceeds 1.5 kg/m³/day, even under fully aerobic conditions in which the dissolved oxygen concentration of water in the reaction tank is 3 mg/L or more. It was also found that the carbon dioxide concentration sensor is adversely affected by this hydrogen sulfide. Further, after about three months of the continuous operation and the continuous measurement, the carbon dioxide concentration sensor became unable to measure or showed a large measurement error. On the other hand, in Example 1 in which the carbon dioxide concentration was measured after the removal of hydrogen sulfide by the desulfurization filter even under conditions in which hydrogen sulfide would be similarly generated, the measured value of carbon dioxide concentration was stabilized even when the continuous operation and the continuous measurement were performed over a long period of time. Therefore, it was found that, by providing the desulfurization filter, the control of adding the nutritive substance based on the carbon dioxide concentration can be optimized for a long period of time.

### Reference Examples 2 to 7

It was examined that the aerobic biological treatment can be controlled by using at least the carbon dioxide concentration. First, common test conditions for Reference Examples 2 to 7 will be described. A single-stage reaction tank shown in FIG. 2 with a volume of 19 L was used to perform biological treatment by aerobic treatment of raw water that is the organic wastewater. The aerobic microorganism was supported on a sponge carrier comprising a hydrophobic polyurethane resin, and such a sponge carrier was filled in the reaction tank at 20% as a bulk volume with respect to the volume of the reaction tank. The residence time in the reaction tank was set to 18 hours. Wastewater containing isopropyl alcohol was used as the raw water. The BOD concentration in the raw water was about 900 mg/L (to be used as the reference concentration), the nitrogen (N) concentration in the raw water was 2 mg/L or less, and the phosphorus (P) concentration was 0.1 mg or less. The BOD volume loading when performing the biological treatment was about 1 kg/m³/day, the water temperature was about 20° C., the dissolved oxygen concentration (DO) of water in the reaction tank was 2 mg/L or more, and the pH of water in the reaction tank was 6.0 to 7.5. Air was supplied to the reaction tank for air diffusion at a flow rate of 3 to 5 L/min.

Enough nutrient salts (nitrogen (N) and phosphorus (P)) were added to the raw water to keep BOD:N:P at 100:5:1, and the concentration of carbon dioxide released from the water in the reaction tank and the pH of the water in the reaction tank were monitored. Such monitoring was repeatedly performed while intentionally changing the BOD concentration in the raw water from 100% to 30% and 60% of the reference concentration. It should be noted that the fact that the BOD concentration of the raw water can be calculated with high accuracy has the same meaning as the accuracy of control of the nutrient salt addition is high.

### Reference Example 2

Assuming that the BOD concentration of the raw water was calculated from the carbon dioxide concentration, the determination coefficient R² was calculated by the single regression analysis for the carbon dioxide concentration and each BOD concentration, and was 0.39.

### Reference Example 3

Assuming that the BOD concentration of the raw water was calculated from the carbon dioxide concentration and the air flow rate, the determination coefficient R² was calculated by the multiple regression analysis for the carbon dioxide concentration, the air flow rate, and each BOD concentration, and was 0.82.

### Reference Example 4

Assuming that the BOD concentration of the raw water was calculated from the carbon dioxide concentration and the air flow rate, the multiplication value of the measured value of the carbon dioxide concentration and the measured value of the air flow rate was obtained. The determined coefficient R² was calculated by the single regression analysis for the multiplication value and each BOD concentration, and was 0.83.

### Reference Example 5

Assuming that the BOD concentration of the raw water was calculated from the carbon dioxide concentration and the pH, the determination coefficient R² was calculated by the multiple regression analysis for the carbon dioxide concentration, the pH, and each BOD concentration, and was 0.40.

### Reference Example 6

Assuming that the BOD concentration of the raw water was calculated from the carbon dioxide concentration, the air flow rate, and the pH, the determination coefficient R² was calculated by the multiple regression analysis for the carbon dioxide concentration, the air flow rate, the pH, and each BOD concentration, and was 0.89.

### Reference Example 7

Assuming that the BOD concentration of the raw water is calculated from the carbon dioxide concentration, the air flow rate, and the pH, the multiplication value of the measured value of the carbon dioxide concentration and the measured value of the air flow rate was obtained. The determined coefficient R² was calculated by the multiple regression analysis for the multiplication value, the pH and each BOD concentration, and was 0.96.

### REFERENCE SIGNS LIST

10 Reaction tank;
11 Carrier;
12 Air diffusion device;
13 Inlet pipe;
14 Gas pipe;
15 Blower;
16 Lid;
21 Nutritive substance storage tank;
22 Nutritious liquid pipe;
23 Pump;
24 Carbon dioxide concentration sensor;
32 Air flow meter;
33 Water quality measurement unit;
40 Control device;
51 Tubular member; and
52 Desulfurization filter.

1. A wastewater treatment method for performing aerobic biological treatment on organic wastewater containing at least one of a sulfur compound and a nitrogen compound in a reaction tank, the water treatment method comprising:
removing the corrosive gas from gas discharged from water in the reaction tank;
measuring carbon dioxide concentration in the gas after removing the corrosive gas; and
controlling the aerobic biological treatment based on the measured carbon dioxide concentration.

2. The wastewater treatment method according to claim 1, wherein BOD treatment loading in the reaction tank when performing the aerobic biological treatment exceeds 1.5 kg/m³/day.

3. The wastewater treatment method according to claim 1, wherein the aerobic biological treatment is controlled by controlling an amount of a nutritive substance added to the organic wastewater.

4. The wastewater treatment method according to claim 1, wherein a fluidized bed is formed in the reaction tank to perform the aerobic biological treatment.

5. The wastewater treatment method according to claim 1, wherein, when a plurality of the reaction tanks are provided in series, removal of the corrosive gas and measurement of the carbon dioxide concentration are performed in the reaction tank in a frontmost stage, and the aerobic biological treatment in the reaction tank of the frontmost stage is controlled based on the measured carbon dioxide concentration.

6. A wastewater treatment apparatus comprising:
a reaction tank that performs aerobic biological treatment on organic wastewater containing at least one of a sulfur compound and a nitrogen compound;
a filter for removing corrosive gas from gas discharged from water in the reaction tank;
a sensor for measuring carbon dioxide concentration contained in the gas after the corrosive gas has been removed; and
a control device for controlling the aerobic biological treatment based on the carbon dioxide concentration measured by the measurement means.

7. The wastewater treatment apparatus according to claim 6, wherein the aerobic biological treatment is performed under a condition in which BOD treatment loading in the reaction tank exceeds 1.5 kg/m³/day.

8. The wastewater treatment apparatus according to claim 6, further comprising an addition means for adding a nutritive substance to the organic wastewater,
wherein the control device controls an additive amount of the nutritive substance by the addition means based on the carbon dioxide hydrogen concentration.

9. The wastewater treatment apparatus according to claim 6, wherein the reaction tank is a fluidized bed type reaction tank.

10. The wastewater treatment apparatus according to claim 6,
wherein a plurality of the reaction tanks are provided in series,
wherein the filter and the sensor are provided to the reaction tank in a frontmost stage, and
wherein the control device controls the aerobic biological treatment in the reaction tank in the frontmost stage.

11. The wastewater treatment method according to claim 2, wherein the aerobic biological treatment is controlled by controlling an amount of a nutritive substance added to the organic wastewater.

12. The wastewater treatment apparatus according to claim 7, further comprising an addition means for adding a nutritive substance to the organic wastewater,
wherein the control device controls an additive amount of the nutritive substance by the addition means based on the carbon dioxide concentration.
